(19) United States
(12) Patent Application Publication
(10) Pub. No.: US 2008/0133388 A1
(43) Pub. Date: Jun. 5, 2008

(54) Invoice exception management

(76) Inventors: Sergey Alekseev, Rauenberg (DE); Paola Sala, Heidelberg (DE); Robert Reiner, Waghaeusel-Kirrlach (DE); Benjamin Klehr, Rastatt (DE); Pascal Hochwarth, Muehlhausen (DE); Tanja Soehngen, Altlussheim (DE)

Correspondence Address: FISH & RICHARDSON, P.C., PO BOX 1022, MINNEAPOLIS, MN, 55440-1022, US

(21) Appl. No.: 11/607,145

(22) Filed: Dec. 1, 2006

(51) Int. Cl. G06Q 40/00

(52) U.S. Cl. 705/34

(57) ABSTRACT

The disclosure provides a system, method, and software for facilitating invoice exception management. Particularly, this disclosure describes systems, method, and software for facilitating invoice exception management. The software comprises computer readable instructions. When executed, the software is operable to receive an invoice into a distributed business application. The software can identify an exception to the invoice. If an exception to the invoice is identified, the software automatically presents resolution options for the identified exception to a user via an invoice center interface.

### TECHNICAL FIELD

This disclosure relates to data processing and, more particularly, to a system, method, and software for facilitating invoice exception management.

### BACKGROUND

One problem associated with invoice management and processing is that it is often difficult to effectively process an invoice based solely on the invoice data received from the vendor. Further, the invoice data received from a vendor is often incomplete, incorrect, or fraudulent. Such problems may include wrong order amount (quantity deviation), price deviation, wrong reference or purchase order (vendor doesn't match), tax deviation, duplication processing, internal deviations (our cost center was entered incorrectly), external error (invalid invoice based on header not matching lines, no currency, legally required date missing, etc). Accordingly, processing invoices generally includes two parts: keying in the details and the problem reconciliation. While some invoicing system attempt to automatically reconcile certain types of problems, the failure of this automatic reconciliation (or where the automatic reconciliation isn't available) require the invoice clerk to remember (or find out) what to do or to determine the appropriate contact when the problem occurs.

### SUMMARY

The disclosure provides or describes various systems, methods, and software for facilitating invoice exception management. For example, this disclosure describes invoice management software for facilitating invoice exception resolution. The software comprises computer readable instructions that, when executed, is operable to receive an invoice into a distributed business application. The software can identify an exception to the invoice. If an exception to the invoice is identified, the software automatically presents resolution options for the identified exception to a user via an invoice center interface.

The details of these and other aspects and embodiments of the disclosure are set forth in the accompanying drawings and the description below. For example, each of the foregoing—as well as other disclosed—example software and implemented techniques may otherwise include or represent computer implementable methods. Moreover, some or all of these aspects may be further included in respective systems for facilitating invoice exception management. Certain features, objects, and advantages of the various embodiments will be apparent from the description, drawings, and the claims.

### DESCRIPTION OF DRAWINGS

FIG. 1 is a block diagram showing an example of a system for facilitating invoice exception management including an invoice management system;

FIG. 2 is a block diagram showing an example of a system that provides intranet/internet access to several integrated backend systems;

FIG. 3A is a user interface showing an example of a general invoice data view;

FIG. 3B is a user interface showing an example of a detailed invoice data view;

FIG. 4A is a process component model showing an example of an interaction model for invoice creation;

FIG. 4B is a process component model showing an example of an interaction model for invoice verification;

FIG. 4C is a process component model showing an example of an interaction model for issuing notifications based on a created supplier invoice;

FIG. 4D is a process component model showing an example of an interaction model for supplier invoice exception resolution;

FIG. 5A is a user interface showing an example of an invoice work center overview;

FIG. 5B is a user interface showing an example of an invoice work center service map;

FIG. 5C is a user interface showing an example of an invoice creation page;

FIG. 5D is a user interface showing an example of an invoice management page;

FIG. 6A is a user interface showing an example of a supplier invoicing overview of an SRM module;

FIG. 6B is a user interface showing an example of a supplier invoicing exception list of the SRM module;

FIG. 7A is a user interface showing an example of a supplier invoice duplicate comparison of the SRM module;

FIG. 7B is a user interface showing an example of a supplier original invoice duplicate comparison of the SRM module;

FIG. 7C is a user interface showing an example of the supplier invoice duplicate comparison of the SRM module;

FIG. 7D is a user interface showing an example of a supplier invoice exception clarification request of the SRM module;

FIG. 7E is a user interface showing an example of a supplier invoice exception view of the SRM module;

FIG. 7F is a user interface showing an example of the supplier invoicing exception list of the SRM module;

FIG. 7G is a user interface showing an example of a supplier invoice exception clarification form of the SRM module;

FIG. 7H is a user interface showing an example of the supplier invoice exception clarification form of the SRM module;

FIG. 8A is a user interface showing an example of the supplier invoicing exception list of the SRM module;

FIG. 8B is a user interface showing an example of a supplier invoicing exception detail view of the SRM module;

FIG. 8C is a user interface showing an example of a supplier invoice exception clarification request of the SRM module;

FIG. 8D is a user interface showing an example of the supplier invoice exception view of the SRM module;

FIG. 8E is a user interface showing an example of a portal notifications inbox of a goods recipient;

FIG. 8F is a user interface showing an example of the supplier invoice exception clarification form of the SRM module;

FIG. 8G is a user interface showing an example of the supplier invoicing exception list of the SRM module; and

FIG. 9 is a flow chart showing an example of a method for facilitating invoice exception management.

### DETAILED DESCRIPTION

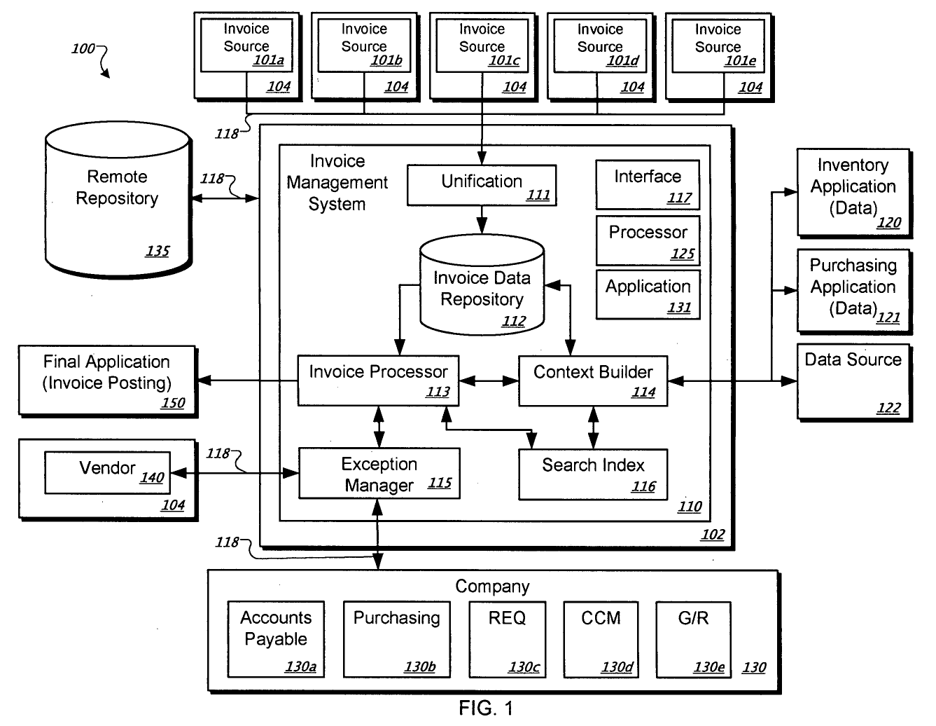

Embodiments of the present disclosure include a software architecture for facilitating invoice exception management. FIG. 1 illustrates a system 100 including an invoice management system (IMS) 110 according to one embodiment of the present invention. The IMS 110 processes invoices, credit memos, subsequent credits and debits, and invoice exceptions. The IMS 110 processes incoming invoices (with and without purchase order reference) on an exception basis. The IMS 110 aides an invoicing clerk who checks the actual incoming invoices based on internal information (purchase orders, goods receipts, and others). In certain embodiments, the invoicing clerk is a person who works with the IMS 110. For example, system 100 may implement various roles, one of which targets the invoicing clerk (invoicing clerk role) who is responsible for the incoming invoices in the logistics department. The IMS 110 has an associated portal providing a central hub for an invoicing clerk where the most important and frequently used invoicing transactions are gathered in a compact and directly accessible form. In case of exceptions or errors, IMS 110 can trigger a variety of workflows and other activities including informing suppliers and non-invoice specialist users, that is, purchasers, about potential conflict situations and allowing them to correct invoices using appropriate communication tools, that is, e-mails with interactive forms. The process of exception handling can be monitored in an appropriate work center. The IMS 110 processes incoming invoices on top of existing invoice verification. The IMS 110 maps incoming invoices against existing documents, like purchase orders or receiving documents. If no exceptions exist, then IMS 110 performs an automatic posting of the incoming invoice. Otherwise, in the case of exceptions, IMS 110 triggers various workflow and monitoring activities, including notification of vendors about the existing exception. IMS 110 may manage invoices without reference to other documents. IMS 110 assigns internal approvers and contact persons to confirm correctness of the invoice data. IMS 110 makes vendor invoice information available for other applications and interfaces.

Invoices and their associated data are received from multiple distinct sources 101A-10E in different formats. For example, invoices may be received in paper form through traditional channels such as through the postal system, or electronically through a variety of channels such as a web portal, email, or facsimile. If invoices are received in paper or other non-electronic form, an optical character recognizer (OCR) may be used to translate the data from the paper invoice into electronic form, for example. The incoming invoice data can be received and processed in different formats. For example, invoice data may be received as email text, PDF files, text documents, images, extended markup language (XML), electronic data interchange (EDI), or other structured or unstructured, standard or non-standard formats. According to one embodiment of the present invention, invoice management system 110 may include a unification engine 111 that transforms the incoming invoice data into a common format. The step of transforming the incoming structured and/or unstructured invoice data into a common format is sometimes referred to as a “normalization” step. The normalized invoice data may then be stored in an invoice data repository 112 for centralized access and management.

System 100 is typically a distributed client/server system that spans one or more networks such as 118. In such embodiments, data may be communicated or stored in an encrypted format using any standard or proprietary encryption algorithm. But system 100 may be in a dedicated enterprise environment—across a local area network or subnet—or any other suitable environment without departing from the scope of this disclosure. For example, some components, such as invoice management system 110, executed by example server 102, may be accessed by a manufacturer, a third party data processor for this and/or other manufacturers, and others. Turning to the illustrated embodiment, system 100 includes or is communicably coupled with server 102, one or more invoice source clients 104A-E with vendors 140 or customers/companies 130, and network 118. Generally, vendor 140 may be any local or remote business or other entity operable to provide goods, services, consulting, or other similar offerings that may benefit customers 130 in some way. Often, these vendors 140 may sell products created by a third party manufacturer, such as one implementing or managing example server 102.

Server 102 comprises an electronic computing device operable to receive, transmit, process, and store data associated with system 100. Generally, FIG. 1 provides merely one example of computers that may be used with the disclosure. Each computer is generally intended to encompass any suitable processing device. For example, although FIG. 1 illustrates one server 102 that may be used with the disclosure, system 100 can be implemented using computers other than servers, as well as a server pool. Indeed, server 102 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 102 may be adapted to execute any operating system including Linux, UNIX, Windows Server, or any other suitable operating system. According to one embodiment, server 102 may also include or be communicably coupled with a web server and/or a mail server.

As illustrated (but not required), server 102 is communicably coupled with a relatively remote repository 135 over a portion of network 118. Repository 135 is any intra-enterprise, inter-enterprise, regional, nationwide, or substantially national electronic storage facility, data processing center, or archive. Repository 135 may be a central database communicably coupled with one or more servers 110 and clients 104A-E via a virtual private network (VPN), Secure Shell (SSH) tunnel, or other secure network connection. Repository 135 may be physically or logically located at any appropriate location, including in one of the example enterprises, or off-shore, so long as it remains operable to store information associated with system 100 and communicate such data to server 102, or at least a subset of a plurality of clients 104A-E.

As a possible supplement to or replacement of repository 135, illustrated server 102 includes local memory or invoice data repository 112. Memory 112 may include any memory or database module and may take the form of volatile or non-volatile memory including, without limitation, magnetic media, optical media, random access memory (RAM), read-only memory (ROM), removable media, or any other suitable local or remote memory component. Memory 112 may include any appropriate data such as VPN applications or services, firewall policies, a security or access log, print or other reporting files, HTML files or templates, data classes or object interfaces, related or unrelated software applications or sub-systems, and others.

Memory 112 and/or remote repository 135, collectively memory, may store invoice and other related data in any suitable format. Files and/or data may be stored in one or more tables in a relational database described in terms of SQL statements or scripts. In another embodiment, files and/or data may be formatted, stored, or defined as various data structures in text files, eXtensible Markup Language (XML) documents, Virtual Storage Access Method (VSAM) files, flat files, Btrieve files, comma-separated-value (CSV) files, internal variables, or one or more libraries. For example, the invoice data is stored in an XML format, which may have a predefined schema (e.g., EBPXML), while source 101 and vendor 140 contact information are in a database table. In another example, the information may be stored and/or processed as objects (e.g., invoice, vendor or other partner, manager or other role, associated business objects, and so forth). Invoices may further include references to relevant information stored as tables or objects in other systems (i.e., context). In short, files and/or data may comprise one table or file or a plurality of tables or files stored on one computer or across a plurality of computers in any appropriate format. Indeed, some or all of the files and/or data may be local or remote without departing from the scope of this disclosure and store any type of appropriate data. Moreover, files and/or data may be bundled and/or transmitted in a different format, such as an Adobe Interactive Form, than it was stored in.

Server 102 also includes processor 125. Processor 125 executes instructions and manipulates data to perform the operations of server 102 such as, for example, a central processing unit (CPU), a blade, an application specific integrated circuit (ASIC), or a field-programmable gate array (FPGA). Although FIG. 1 illustrates a single processor 125 in server 102, multiple processors 125 may be used according to particular needs, and reference to processor 125 is meant to include multiple processors 125 where applicable. In the illustrated embodiment, processor 125 executes application 131.

At a high level, application 131 is an application, program, module, process, or other software that performs functions of the server 102, such as invoice processor 113, exception manager 115, search index 116, and context builder 114. In certain cases, system 100 may implement a composite application 131. Regardless of the particular implementation, “software” may include software, firmware, wired or programmed hardware, or any combination thereof as appropriate. Indeed, application 131 may be written or described in any appropriate computer language including C, C++, Java, J#, Visual Basic, assembler, Perl, any suitable version of 4GL, as well as others. For example, returning to the above mentioned composite application, the composite application portions may be implemented as Enterprise Java Beans (EJBs) or the design-time components may have the ability to generate run-time implementations into different platforms, such as Java 2 Platform Enterprise Edition (J2EE), Advanced Business Application Programming (ABAP) objects, or Microsoft's NET. It will be understood that while application 131 may include various sub-modules described above, application 131 may include numerous other sub-modules or may instead be a single multi-tasked module that implements the various features and functionality through various objects, methods, or other processes. Further, while illustrated as internal to server 102, one or more processes associated with application 131 may be stored, referenced, or executed remotely. For example, a portion of application 131 may be a web service that is remotely called, while another portion of application 131 may be an interface object bundled for processing at remote client 104A-E. Moreover, application 131 may be a child or sub-module of another software module or enterprise application (not illustrated) without departing from the scope of this disclosure. Indeed, application 131 may be a hosted solution that allows multiple parties (such as the manufacturer, vendor 140, and customer 130) in different portions of the process to perform the respective processing.

Example application 131 is any business application and may be a composite application, or an application built on other applications, that includes an object access layer (OAL) and a service layer. In this example, application 131 may execute or provide a number of application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help composite application 131 to orchestrate a business process in synchronization with other existing processes (e.g., native processes of enterprise base systems) and leverage existing investments in the IT platform. Further, composite application 131 may run on a heterogeneous IT platform. In doing so, composite application 131 may be cross-functional in that it may drive business processes across different applications, technologies, and organizations. Accordingly, composite application 131 may drive end-to-end business processes across heterogeneous systems or sub-systems. Application 131 may also include or be coupled with a persistence layer and one or more application system-connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes a composite application 131, it may instead be a standalone or (relatively) simple software program. Regardless, application 131 may also perform processing automatically, which may indicate that the appropriate processing is substantially performed by at least one component of system 100. It should be understood that automatically further contemplates any suitable administrator or other user interaction with application 131 or other components of system 100 without departing from the scope of this disclosure.

Application 131 may include, reference, link to, or be communicably coupled with invoice management system 110; in other situations, invoice management system 110 may be a relatively stand-alone application. In one embodiment, invoice management system 110 includes a context builder 114 coupled to invoice data repository 112. Context builder 114 may be used to automatically gather additional information corresponding to each invoice, so that each invoice may be processed faster and more efficiently. Context builder 114 may access other data sources both inside and outside the company to gather additional information corresponding to an invoice. For example, context builder 114 may access data in other software systems or applications, such as an inventory application 120 or purchasing application 121. Furthermore, context builder 114 may access other structured or unstructured data from other data sources, such as network servers, local computers, document repositories, or document management systems (to name just a few) to gather information about purchase orders, goods received, business partners, general ledger, contracts, and contacts. In one embodiment, context builder 114 may allow users or administrators to specify what other sources or types of additional information may be beneficial for processing invoices (as opposed to programmers). Accordingly, relevant data may be gathered by context builder 114 and used to augment incoming invoice data with relevant context so that the invoice may be processed more efficiently. For example, in one embodiment context builder 114 automatically populates invoice data fields in order to reduce or eliminate data entry by a human user. Additional features and functionality may be incorporated into context builder 114 as described below.

Invoice management system 110 further includes an invoice processor software component 113 coupled to both invoice data repository 112 and context builder 114. Invoice processor 113 may use data from invoice data repository 112 and the data gathered by context builder 114 to automatically verify the invoice data. For example, invoice processor 113 may perform checks for duplicate invoices, errors and omissions, fraud, and routing errors. If the invoice data is verified successfully, the invoice data may be posted in a financial application 150, for example. However, if the invoice data is not verified, an exception manager 115 may be invoked to report problems to relevant personnel and control the resolution of the problem.

In one embodiment, exception handler 115 provides functionality to control the processing of invoice exceptions and may further facilitate collaborative resolution of invoice problems. One advantage of the present embodiment is that exception manager 115 may act as a single point for capturing and processing of exceptions and for automating the dispute resolution process using collaborative tools. For example, in one embodiment all exceptions are stored in an exception repository (not shown) for centralized management and an “exception case” may be created by the system. The system may intelligently forward the exception case to different individuals in the company or external individuals if a particular individual's participation is necessary for resolution of the exception. The information transferred between individuals may be intelligently controlled so that each individual only receives the information necessary for solving particular problems. For example, exception manager 115 may forward information about the exception to users in different groups in company 130 such as accounts payable 130A, purchasing 130B, requisitions (“REQ”) 130C, cost center management (CCM) 130D or goods received (G/R, e.g., a manufacturing facility) 130E if the participation of employees in those groups is required to resolve the issue. Exception manager 115 provides flexible automated collaboration between such users and the vendors associated with each invoice. For example, in one embodiment exception manager 115 manages notifications pertaining to exceptions between one or more employees in the company 130 and employees at a vendor 140. Vendor 140 may receive invoice information corresponding to an exception case from a user over email along with comments and an optional interactive form. Vendor 140 may then dispute the exception (e.g., if the exception pertains to a duplicate or fraudulent invoice), confirm the exception or provide additional information via the interactive form, for example. Once the exception is resolved, the exception case is closed and the invoice data may be posted.

Invoice management system 110 may further include a search engine including, for example, a search index 116 that may be accessed by invoice processor 113, context builder 114, and exception manager 115. Invoice processor 113 may use search engine capabilities to access the search index to search for invoice information in the same system or other systems. For example, an index of processed invoices may be maintained, and a search through the index may be made as new invoices enter the system (e.g., for duplicate detection). The index may be a combined subset of multiple database tables that includes a variety of invoice data. Simple checks for the same date or same amount may be performed by a simple database search. However, more complex searches such as “similarity searches” may be performed to find invoice data or context for an invoice. Context builder 114 may access the search index 116 to search for additional information about the invoice. Finally, exception manager 115 may access the search index to allow users to search exception cases or context as described below. Search functionality may also be supplied to users during exception management.

Invoice management system 110 may further include an integration layer. The integration layer may include one or more code modules that interface with other systems or people that are involved in invoice processing. The integration layer enables the system to exchange data (e.g., posting, accessing context, or parking) and perform actions such as sending confirmations, requesting input, obtaining authorizations or running invoice queries, to name just a few. The integration layer includes software components that allow invoice management system 110 to provide communications (e.g., email) between internal company employees. The integration layer may also support electronic communication with and access to information in other software systems and applications. Finally, the integration layer includes software components that allow invoice management system 110 to provide communications (e.g., email) between internal company employees and vendor employees.

Server 102 may also include interface 117 for communicating with other computer systems, such as clients 104A-E, over network 118 in a client-server or other distributed environment. In certain embodiments, server 102 receives data from internal or external senders through interface 117 for storage in memory 112 and/or processing by processor 125. Generally, interface 117 comprises logic encoded in software and/or hardware in a suitable combination and operable to communicate with network 118. More specifically, interface 117 may comprise software supporting one or more communications protocols associated with communications network 118 or hardware operable to communicate physical signals.

Network 118 facilitates wireless or wireline communication between computer server 102 and any other local or remote computer, such as clients 104A-E. Network 118 may be all or a portion of an enterprise or secured network. In another example, network 118 may be a VPN merely between server 102 and client 104A-E across wireline or wireless link. Such an example wireless link may be via 802.11a, 802.11b, 802.11g, 802.20, WiMax, and many others. While illustrated as a single or continuous network, network 118 may be logically divided into various sub-nets or virtual networks without departing from the scope of this disclosure, so long as at least a portion of network 118 may facilitate communications between server 102 and at least one client 104A-E. For example, server 102 may be communicably coupled to repository 135 through one sub-net while communicably coupled to a particular client 104A-E through another. In other words, network 118 encompasses any internal or external network, networks, sub-network, or combination thereof operable to facilitate communications between various computing components in system 100. Network 118 may communicate, for example, Internet Protocol (IP) packets, Frame Relay frames, Asynchronous Transfer Mode (ATM) cells, voice, video, data, and other suitable information between network addresses. Network 118 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 118 may be a secure network associated with the enterprise and authenticated vendors 140 or customers 130, via certain local or remote clients 104A-E.

Client 104A-E is any computing device operable to connect or communicate with server 102 or network 118 using any communication link. At a high level, each client 104A-E includes or executes at least GUI and comprises an electronic computing device operable to receive, transmit, process and store any appropriate data associated with system 100. It will be understood that there may be any number of clients 104A-E communicably coupled to server 102. Further, “client 104A-E” and “user” may be used interchangeably as appropriate without departing from the scope of this disclosure. Moreover, for ease of illustration, each client 104A-E is described in 'terms of being used by one user. But this disclosure contemplates that many users may use one computer or that one user may use multiple computers. As used in this disclosure, client 104A-E is intended to encompass a personal computer, touch screen terminal, workstation, network computer, kiosk, wireless data port, smart phone, personal data assistant (PDA), one or more processors within these or other devices, or any other suitable processing device. For example, client 104A-E may be a PDA operable to wirelessly connect with an external or unsecured network. In another example, client 104A-E may comprise a laptop that includes an input device, such as a keypad, touch screen, mouse, or other device that can accept information, and an output device that conveys information associated with the operation of server 102 or clients 104A-E, including digital data, visual information, or GUI. Both the input device and output device may include fixed or removable storage media such as a magnetic computer disk, CD-ROM, or other suitable media to both receive input from and provide output to users of clients 104A-E through the display, namely, the client portion of GUI or application interface.

GUI comprises a graphical user interface operable to allow the user of client 104A-E to interface with at least a portion of system 100 for any suitable purpose, such as viewing application or other transaction data. Generally, GUI provides the particular user with an efficient and user-friendly presentation of data provided by or communicated within system 100. GUI may comprise a plurality of customizable frames or views having interactive fields, pull-down lists, and buttons operated by the user. GUI may also present a plurality of portals or dashboards. For example, GUI may display a secure webpage that allows users (such as customers 130) to i) request and monitor rebate statuses; or ii) register for warranty, upgrades, or notices. It should be understood that the term graphical user interface may be used in the singular or in the plural to describe one or more graphical user interfaces and each of the displays of a particular graphical user interface. Indeed, reference to GUI may indicate a reference to the front-end or a component of application 131, as well as the particular interface accessible via client 104A-E, as appropriate, without departing from the scope of this disclosure. Therefore, GUI contemplates any graphical user interface, such as a generic web browser or touch screen, that processes information in system 100 and efficiently presents the results to the user. Server 102 can accept data from client 104A-E via the web browser (e.g., Microsoft Internet Explorer or Netscape Navigator) and return the appropriate HTML or XML responses to the browser using network 118.

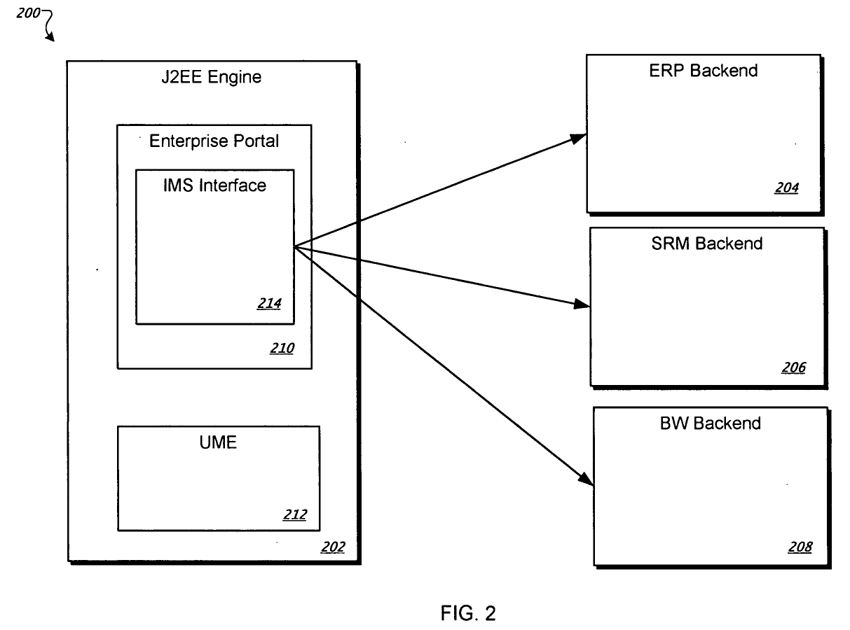

FIG. 2 is a block diagram showing an example of a system 200 that provides intranet/internet access to several integrated backend systems. The system 200 includes a J2EE engine 202, an enterprise resource planning (ERP) backend 204, a supplier relationship management (SRM) backend 206, and a business information warehouse (BW) backend 208. The ERP backend 204 manages business processes, such as manufacturing, supply chains, financials, customer relationship management, and human resources. The SRM backend 206 manages supplier related processes, such as supplier procurement, supplier qualification, supplier negotiation, and supplier contract management. The BW backend 208 manages business information, such as analyzing business information, generating reports based on business information, and warehousing business information.

The J2EE engine 202 includes an enterprise portal 210 and a user management engine 212. The user management engine 212 provides for web-based user management. The enterprise portal 210 provides web-based access to data and applications in the system 200. The enterprise portal 210 includes a user interface 214 to the IMS 110. The interface 214 integrates access to data and services provided by the ERP backend 204, the SRM backend 206, and the BW backend 208.

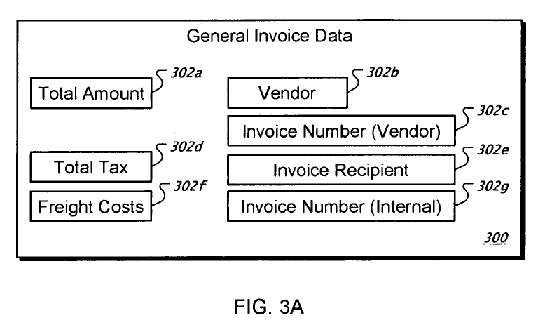

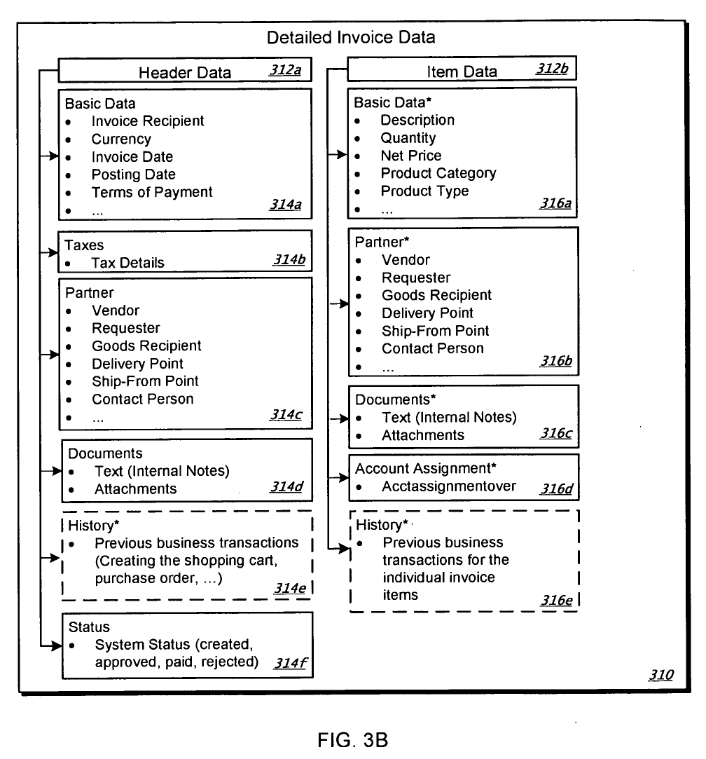

FIG. 3A is a user interface showing an example of a general invoice data view 300. The view 300 includes a total invoice amount 302a, a vendor 302b, a vendor invoice number 302c, a total tax 302d, an invoice recipient 302e, freight costs 302f, and an internal invoice number 302g. FIG. 3B is a user interface showing an example of a detailed invoice data view 310. The view 310 includes header data 312a and item data 312b.

The example header data 312a includes basic data 314a, taxes 314b, partner data 314c, documents 314d, history 314e, and status data 314f. The basic data 314a includes information such as an invoice recipient, a currency, an invoice date, a posting date, and terms of payment. The taxes 314b include tax detail information. The partner data 314c includes information such as a vendor, a requestor, a goods recipient, a delivery point, a ship-from point, and a contact person. The documents 314d include text and attachments. The history 314e includes previous business transactions, such as creating a shopping cart or a purchase order. The status data 314f includes a system status, such as created, approved, paid, or rejected.

The example item data 312b includes basic data 316a, partner data 316b, documents 316c, account assignment data 316d, and history 316e. The basic data 316a includes information such as a description, a quantity, a net price, a product category, and a product type. The partner data 316b includes information such as a vendor, a requestor, a goods recipient, a delivery point, a ship-from point, and a contact person. The documents 316c include text and attachments. The history 316e includes previous business transactions for the individual invoice items. Of course, the illustrated invoice and items data 312a and 312b are for example purposes only and other implementations may include, present, or utilize none, some, all, as well as other data.

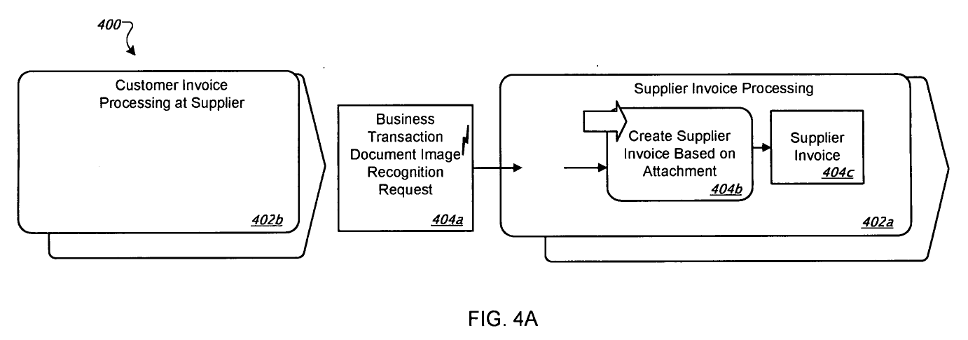

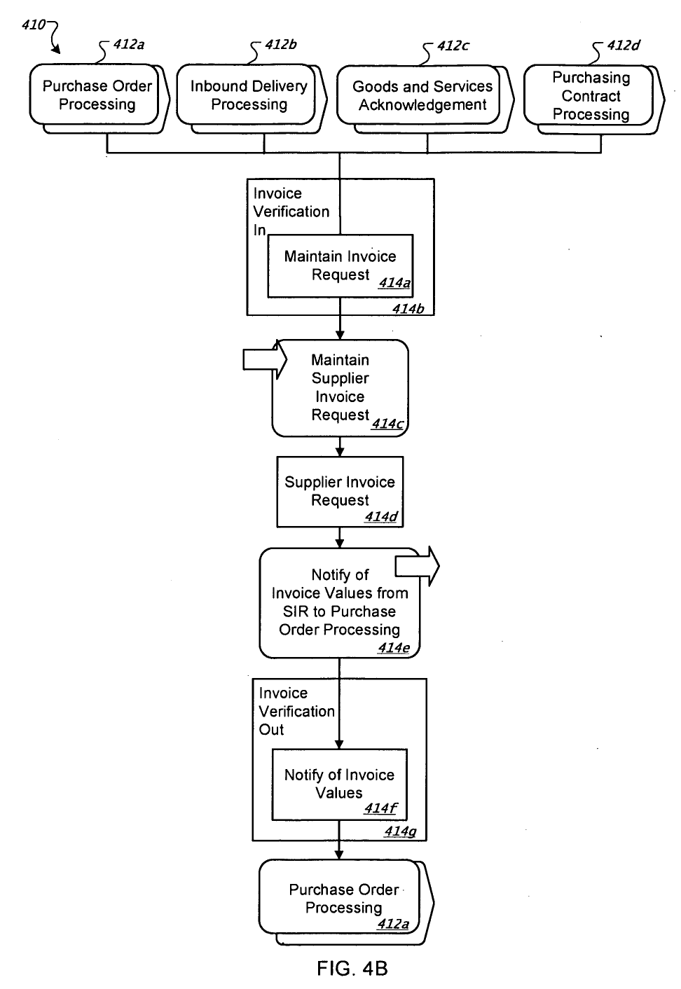

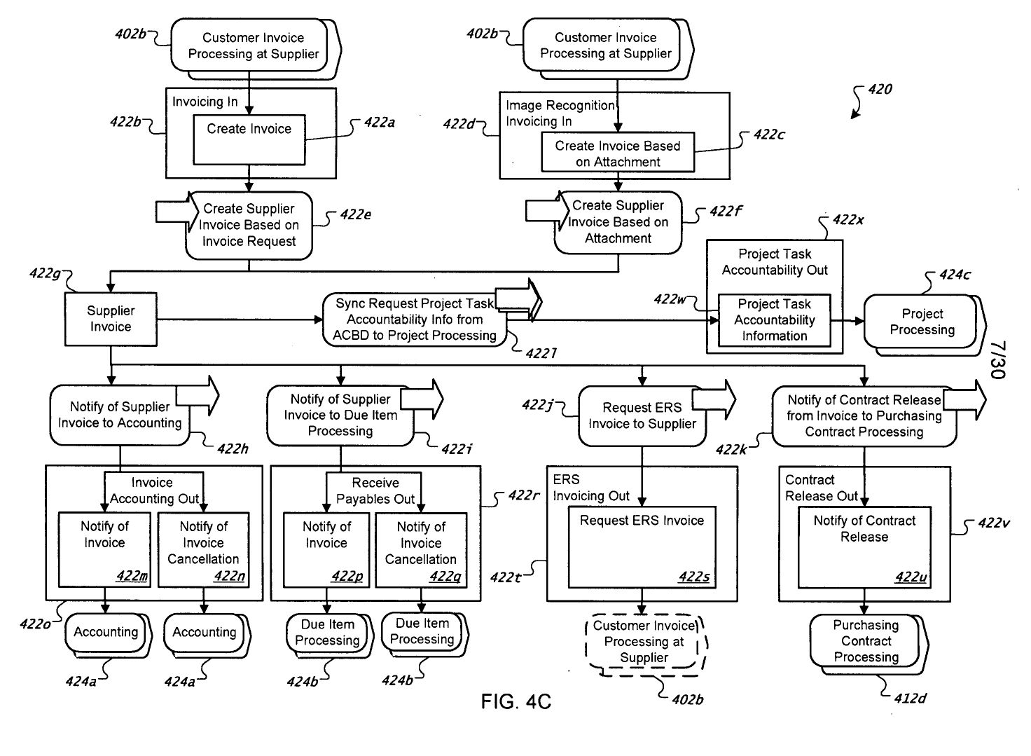

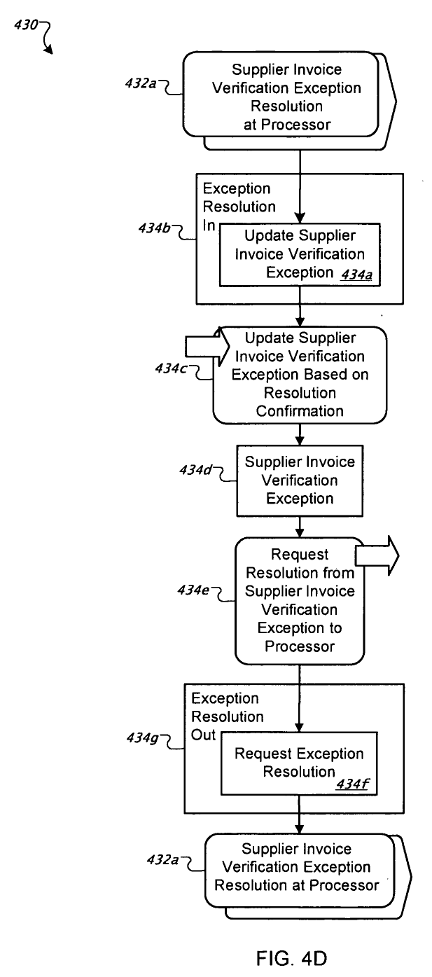

FIG. 4A is a process component model showing an example of an interaction model 400 for invoice creation. A supplier invoice processing process component 402a receives a business transaction document image recognition request business object 404a from a customer invoice processing at supplier process component 402b. The business transaction document image recognition request business object 404a initiates a create supplier invoice based on attachment process agent 404b. The create supplier invoice based on attachment process agent 404b creates a supplier invoice business object 404c.

FIG. 4B is a process component model showing an example of an interaction model 410 for invoice verification. Process components 412a-d including purchase order processing, inbound delivery processing, goods and service acknowledgement, and purchase contract processing, respectively, may initiate a maintain invoice request operation 414a in an invoice verification in interface 414b. The maintain invoice request operation 414a invokes a maintain supplier invoice request inbound process agent 414c. The maintain supplier invoice request process agent 414c creates a supplier invoice request business object 414d. The supplier invoice request business object 414d invokes a notify of invoice values from SIR to purchase order processing outbound process agent 414e. The notify of invoice values from SIR to purchase order processing outbound process agent 414e initiates a notify of invoice values operation 414f within an invoice verification out interface 414g. The notify of invoice values operation 414f notifies the purchase order processing process component 412a of the invoice values.

FIG. 4C is a process component model showing an example of an interaction model 420 for issuing notifications based on a created supplier invoice. The customer invoice processing at supplier process component 402b may initiate either a create invoice operation 422a within an invoicing in interface 422b or a create invoice based on attachment operation 422c within an image recognition invoicing in interface 422d. The create invoice operation 422a invokes a create supplier invoice based on invoice request inbound process agent 422e, while the create invoice based on attachment operation 422c invokes a create supplier invoice based on attachment inbound process agent 422f. The create supplier invoice based on invoice request inbound process agent 422e and/or the create supplier invoice based on attachment inbound process agent 422f create a supplier invoice business object 422g. The supplier invoice business object 422g invokes outbound process agents 422h-1 to notify of supplier invoice to accounting, notify of supplier invoice to due item processing, request ERS invoice to supplier, notify of contract release from invoice to purchase contract processing, and sync request project task accountability information from ACBD to project processing, respectively.

The notify of supplier invoice to accounting outbound process agent 422h initiates a notify of invoice operation 422m and/or a notify of invoice cancellation operation 422n within an invoice accounting out interface 422o. The notify of invoice operation 422m notifies an accounting process component 424a of the invoice operation; The notify of invoice cancellation operation 422n notifies the accounting process component 424a of the invoice cancellation operation.

The notify of supplier invoice to due item processing outbound process agent 422i initiates a notify of invoice operation 422p and/or a notify of invoice cancellation operation 422q within a receivables payables out interface 422r. The notify of invoice operation 422p notifies a due item processing process component 424b of the invoice operation. The notify of invoice cancellation operation 422q notifies the due item processing process component 424b of the invoice cancellation operation.

The request ERS invoice to supplier outbound process agent 422j initiates a request ERS invoice operation 422s within an ERS invoicing out interface 422t. The request ERS invoice operation 422s requests from the customer invoice processing at supplier process component 402b an ERS invoice.

The notify of contract release from invoice to purchase contract processing outbound process agent 422k initiates a notify of contract release operation 422u within a contract release out interface 422v. The notify of contract release operation 422u notifies the purchase contract processing process component 412d of the contract release operation.

The sync request project task accountability info from ACBD to project processing outbound process agent 422l initiates a request project task accountability information operation 422w within a project task accountability out interface 422x. The request project task accountability information operation 422w requests from a project processing process component 424c project task accountability information.

FIG. 4D is a process component model showing an example of an interaction model 430 for supplier invoice exception resolution. A supplier invoice verification exception resolution at processor process component 432a initiates an update supplier invoice verification exception operation 434a within an exception resolution in interface 434b. The update supplier invoice verification exception operation 434a invokes an update supplier invoice verification exception based on resolution confirmation inbound process agent 434c. The update supplier invoice verification exception based on resolution confirmation inbound process agent 434c creates a supplier invoice verification exception business object 434d. The supplier invoice verification exception business object 434d invokes a request resolution from supplier invoice verification exception to processor outbound process agent 434e. The request resolution from supplier invoice verification exception to processor outbound process agent 434e initiates a request exception resolution operation 434f within an exception resolution out interface 434g. The request exception resolution operation 434f requests from the supplier invoice verification exception resolution at processor process component 432a an exception resolution.

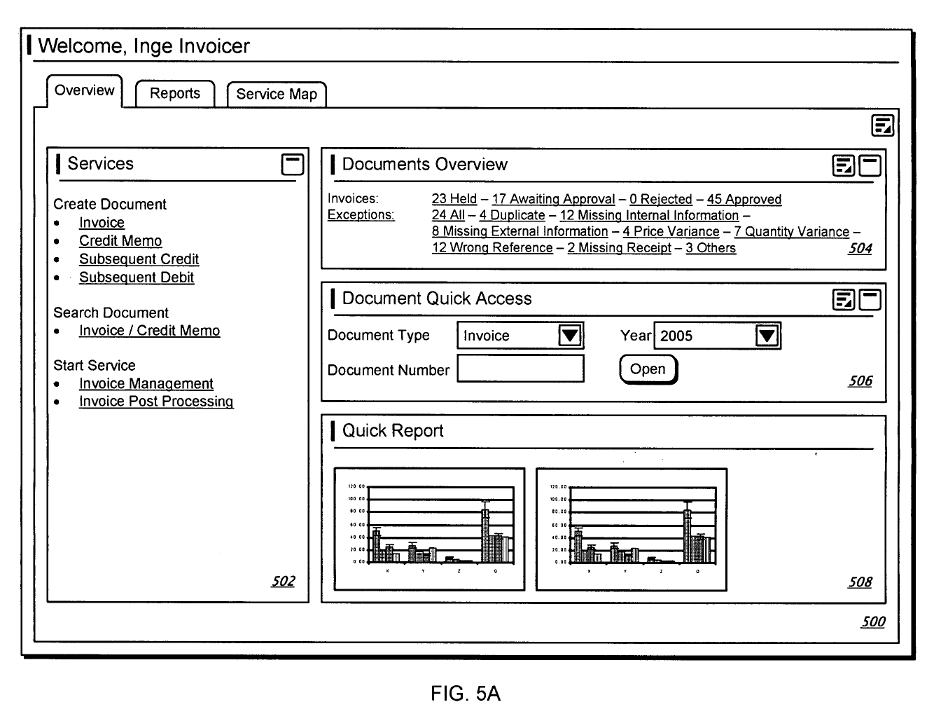

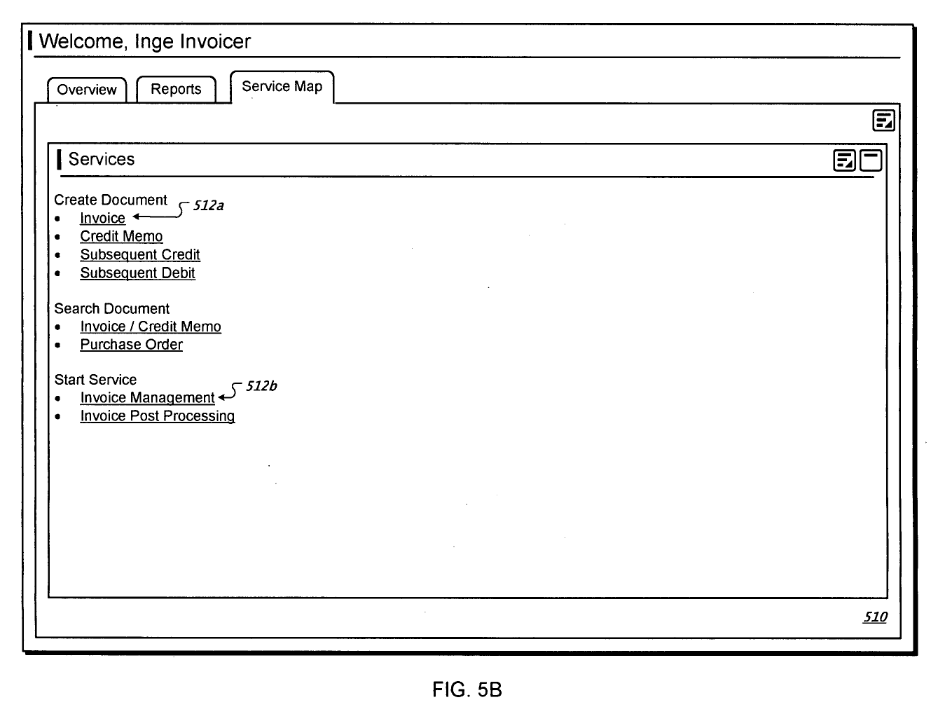

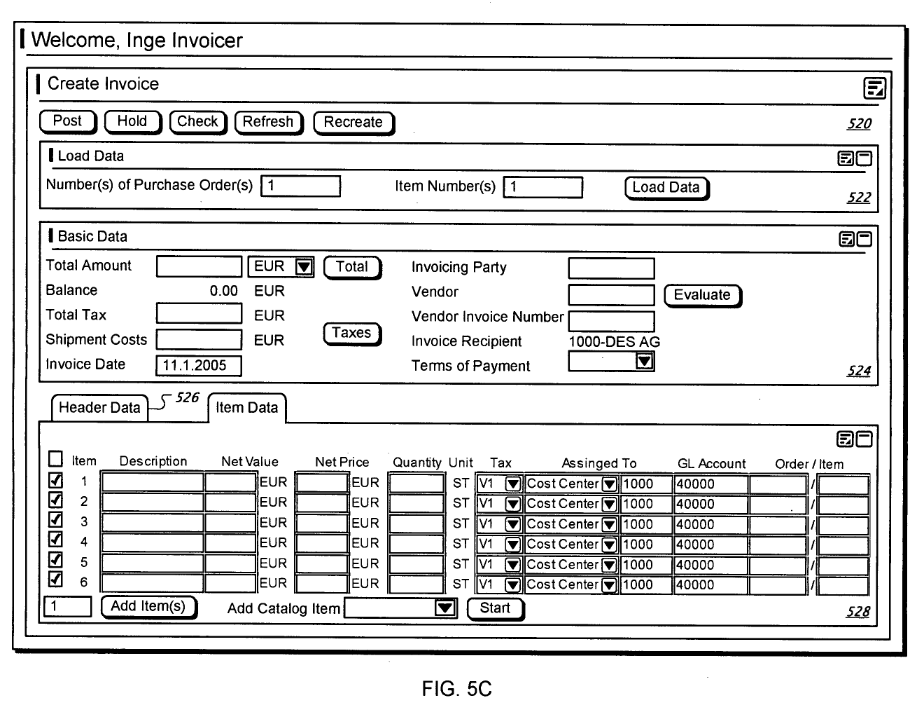

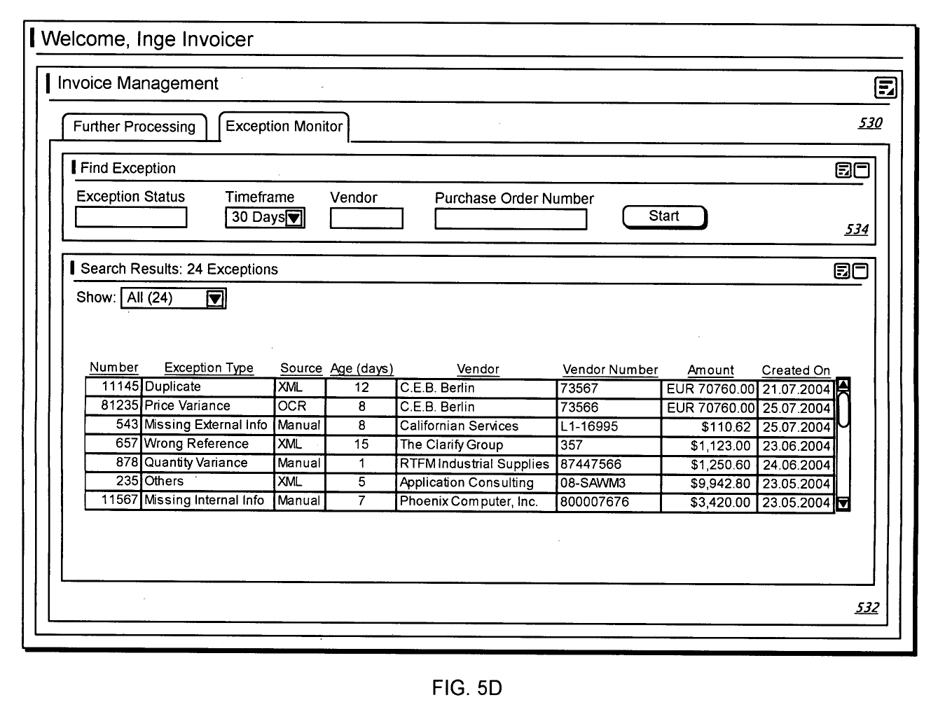

FIG. 5A is a user interface showing an example of an invoice work center overview 500. The overview 500 includes four areas: a common tasks area 502, a documents overview area 504, a documents quick access area 506, and a quick reports area 508. The common tasks area 502 contains links to the respective IMS services. The services subsequently open parameterized according to the chosen link.

The documents overview area 504 contains two documents (invoices and exceptions) and horizontally lists the number of documents found for each document. For invoices, this number is status based, for exceptions it's type based. The services display a worklist with the respective document, filtered according to the chosen number criteria.

The document quick access area 506 allows for a quick access to documents of which the user knows the identifier number. After selecting a document type, entering the number and clicking on “open,” a new window opens up, displaying the selected document in the respective IMS service.

The quick reports area 508 contains a distinctive BW report in a small display mode. Clicking on the more details link opens up the respective full BW report in a new window.

FIG. 5B is a user interface showing an example of an invoice work center service map 510. The map 510 provides a list of links to services available to a user having an invoicing clerk role. Particularly, the map 510 includes a link to create an invoice 512a and a link to manage invoices 512b.

FIG. 5C is user interface showing an example of an invoice creation page 520. The page 520 includes a load data area 522 that allows a user to generate an invoice from one or more purchase orders or purchase order items by inputting purchase order identifiers and/or purchase order item identifiers. The page 520 also includes a basic data area 524 where the user may input or modify general invoice data as described with respect to FIG. 3A. In addition, the page 520 includes a header tab 526 and an item tab 528. The header tab 526 allows a user to input or modify the header data 312a and the item tab 528 allows a user to input or modify the item data 312b as described with respect to FIG. 3B.

FIG. 5D is a user interface showing an example of an invoice management page 530. The page 530 includes an invoice exception monitor tab 532. The tab 532 lists information regarding invoice exceptions, such as an invoice number, a type of the exception, a source of the invoice, an age of the exception, a vendor name, a vendor invoice number, an amount of the invoice, and a date the exception was created. A user may query for particular invoice exceptions by making inputs using query controls in a find exception area 534.

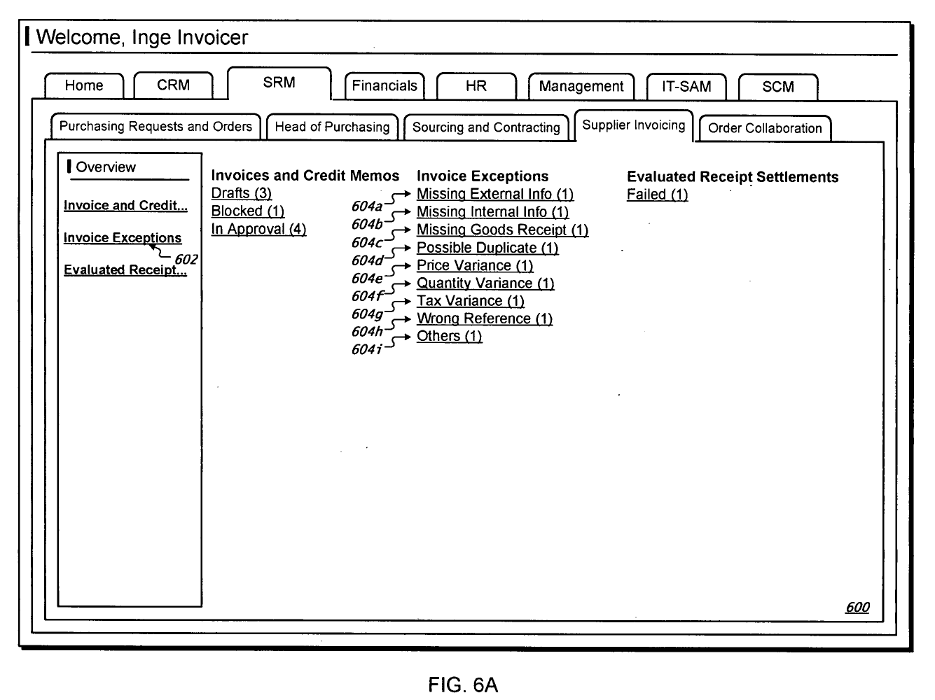

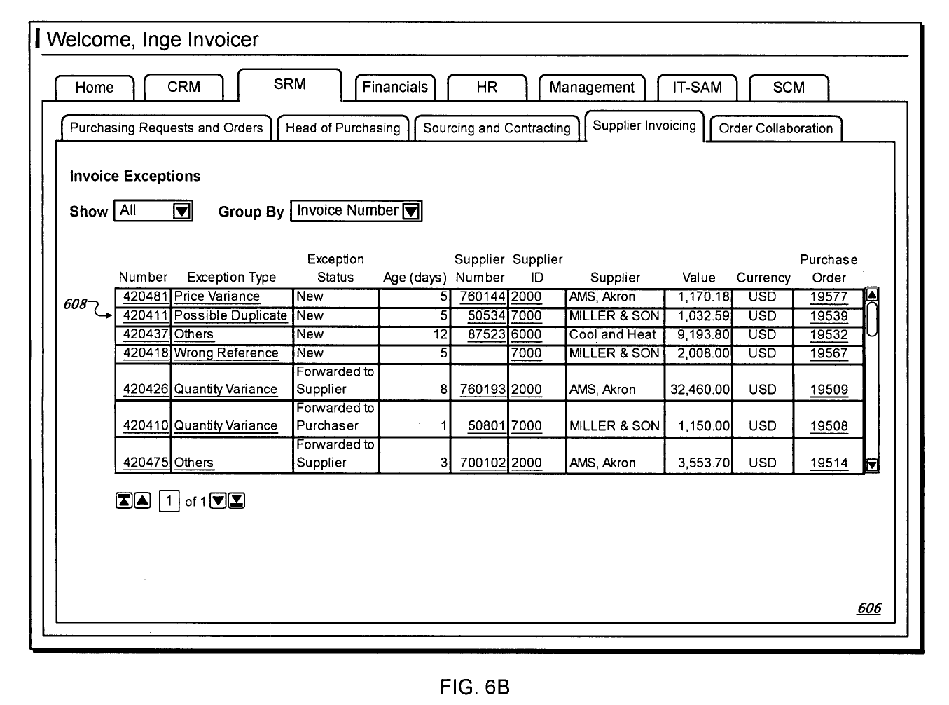

FIG. 6A is a user interface showing an example of a supplier invoicing overview 600 of an SRM module. The overview 600 may be provided by the IMS interface 214 within the portal 210. The overview 600 may be viewed by an employee of the IMS company or an external user, such as a third party user associated with a supplier system. The overview 600 presents a quick link 602 to invoice exceptions as well as links 604a-i to individual exception types, such as invoice duplication, missing external information, missing internal information, missing goods receipt, incorrect reference, approval overdue, price variance, quantity variance, and tax variance. Each link to an individual exception type also has an associated indication of the number of exceptions of that type. Here, the user selects the invoice quick link 602 and is directed to a list of invoice exceptions.

FIG. 6B is a user interface showing an example of a supplier invoicing exception list 606 of the SRM module. The list 606 may be provided by the IMS interface 214 within the portal 210. The list 606 includes invoice exceptions identified by the IMS 110. In particular, the list 606 includes an invoice 608 that the IMS 110 has identified as a possible duplicate. Here, the user selects the invoice exception 608 and is directed to a detailed view of the invoice exception 608.

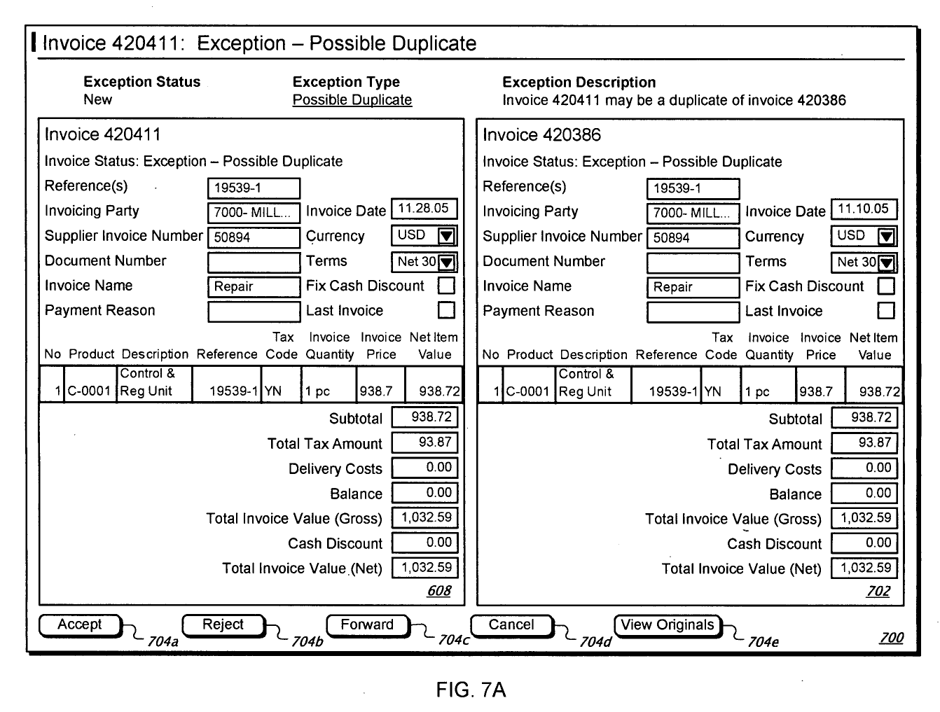

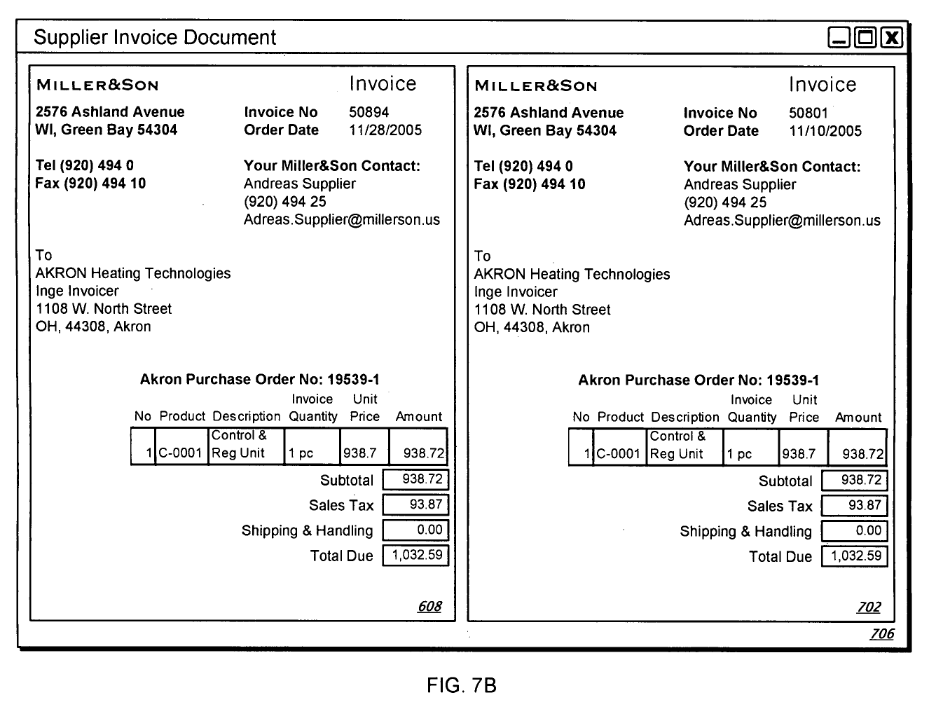

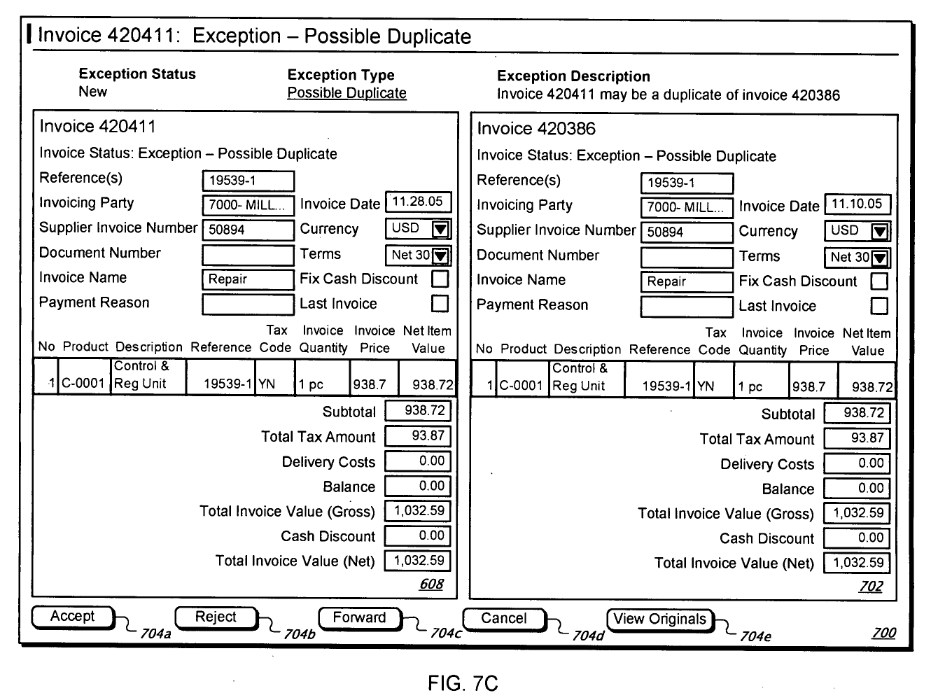

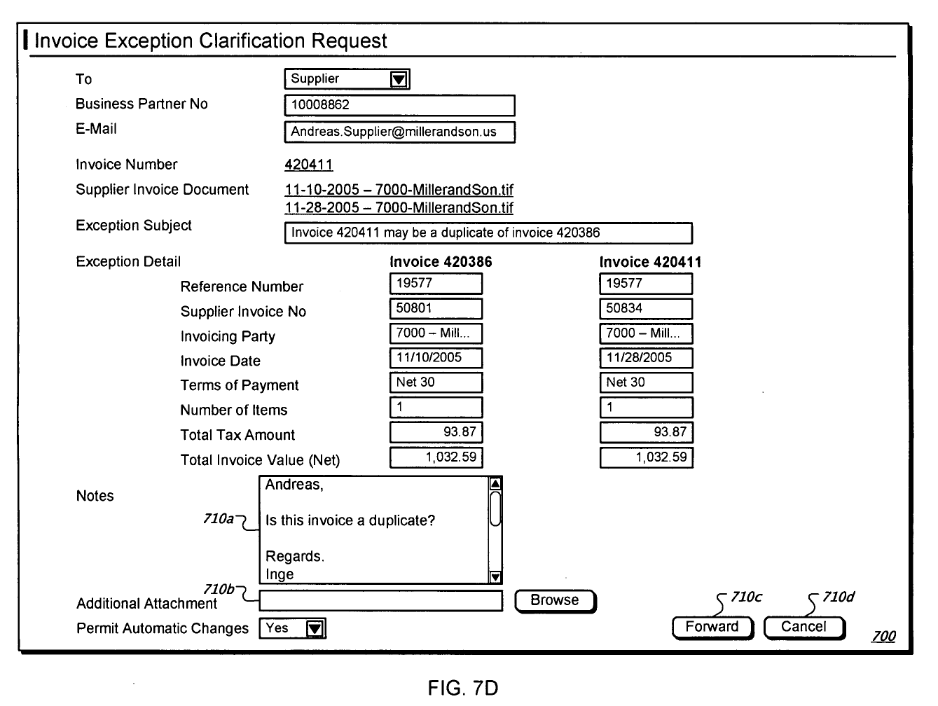

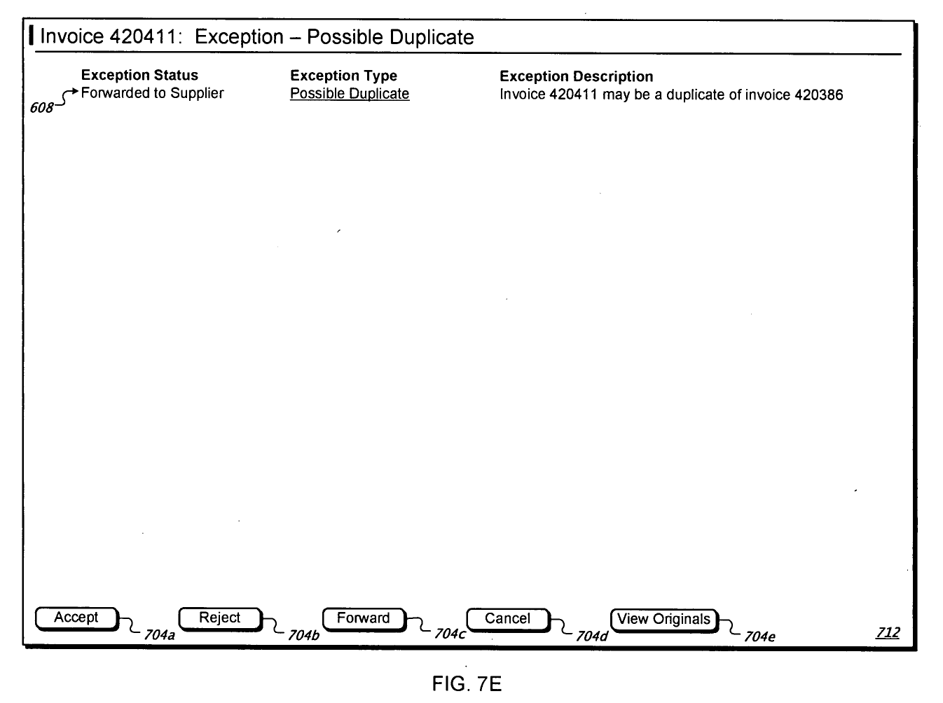

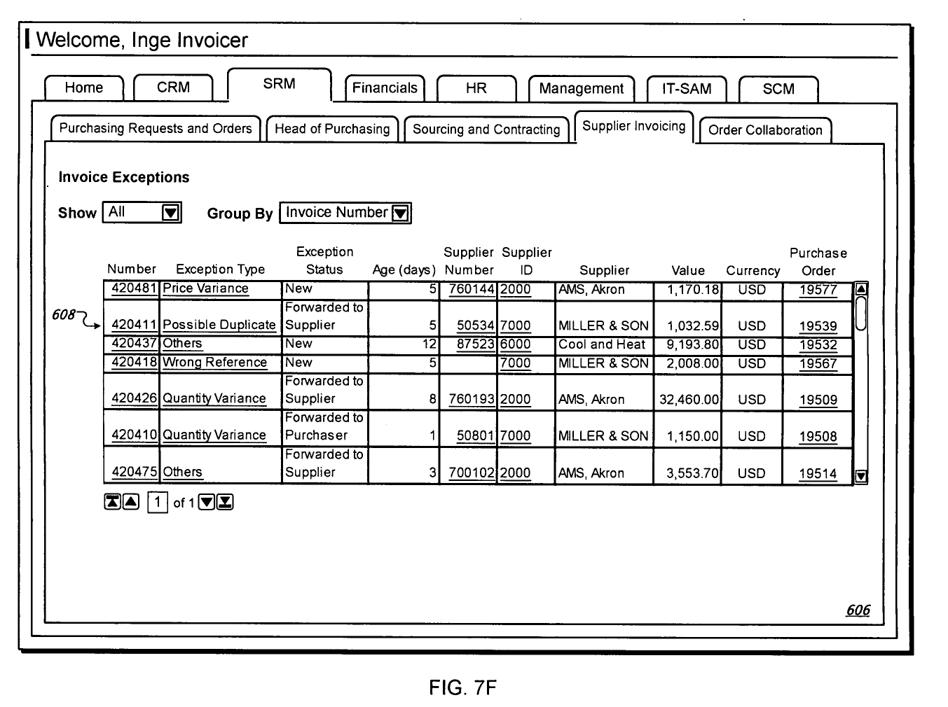

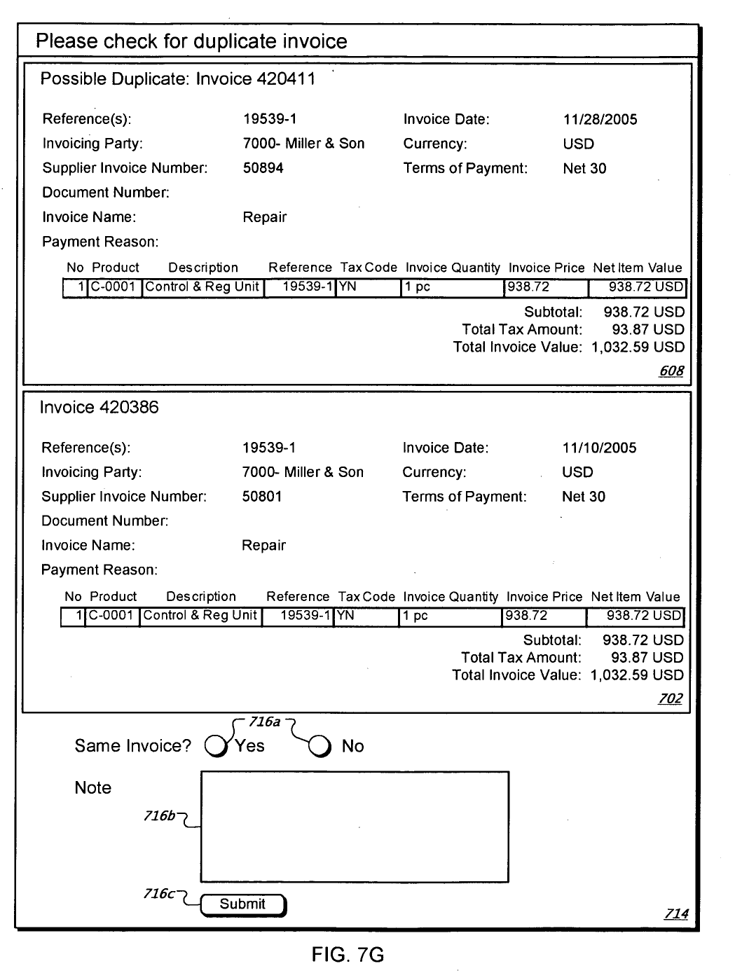

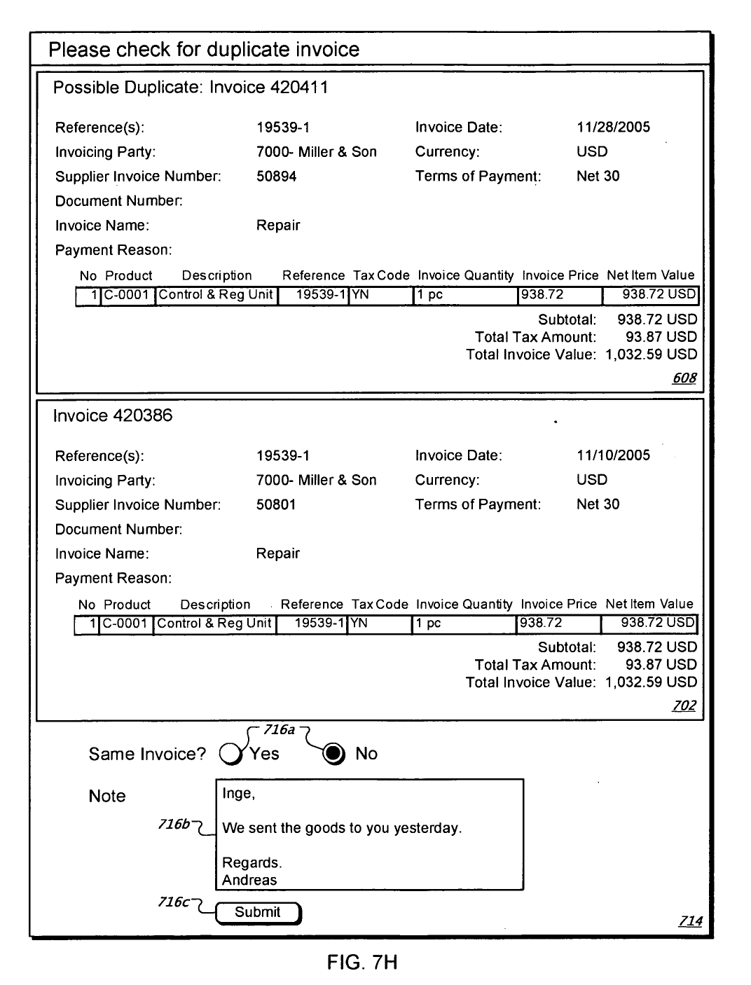

FIG. 7A is a user interface showing an example of a supplier invoice duplicate comparison 700 of the SRM module. The comparison 700 may be provided by the IMS interface 214 within the portal 210. The comparison 700 includes the invoicing data for the exception invoice 608 as well as an invoice 702 identified as the possible duplicate of the invoice 608. The invoice data for each invoice includes an invoice reference number, an invoicing party, an invoice date, a supplier invoice number, terms of payment, an invoice name, a fix cash discount indicator, a payment reason, a last invoice indicator, product information, and invoice costs/charges/credits. The comparison 700 includes controls 704a-e that allow a user to accept the exception, reject the exception, forward the exception, cancel viewing the exception, and view the original invoices, respectively. Here, the user selects the control 704e and is directed to electronic copies of the original invoice documents.

FIG. 7B is a user interface showing an example of a supplier original invoice duplicate comparison 706 of the SRM module. The comparison 706 may be provided by the IMS interface 214 within the portal 210. The comparison 706 includes an electronic copy of the original documents for the invoices 608 and 702. Here, the user closes the comparison 706 after reviewing the original documents.

FIG. 7C is a user interface showing an example of the supplier invoice duplicate comparison 700 of the SRM module. At this point, the user in not certain whether or not the invoices 608 and 702 are duplicates of one another. The user will contact the supplier associated with the invoices 608 and 702 for input. Alternatively, the user could seek input from an internal contact. Here, the user selects the forward control 704c and is directed to a clarification request form.

FIG. 7D is a user interface showing an example of a supplier invoice exception clarification request 708 of the SRM module. The request 708 may be provided by the IMS interface 214 within the portal 210. The request 708 includes the invoicing data for the invoices 608 and 702. The request 708 includes controls 710a-d to add a note, attach a document, send, or cancel the request 708, respectively. Here, the user selects the send control 710c and the request 708 is sent to the supplier for clarification of the exception.

FIG. 7E is a user interface showing an example of a supplier invoice exception view 712 of the SRM module. The view 712 may be provided by the IMS interface. 214 within the portal 210. As a result of forwarding the exception to the supplier, the view 712 now indicates that the invoice 608 has a “forwarded to supplier” status, while the type remains as “possible duplicate:” Here, the user selects the cancel control 704d and is directed back to the list 606.

FIG. 7F is a user interface showing an example of the supplier invoicing exception list 606 of the SRM module. The list 606 also indicates that the invoice 608 is now in the “forwarded to supplier” state.

FIG. 7G is a user interface showing an example of a supplier invoice exception clarification form 714 of the SRM module. The form 714 may be provided by the IMS interface 214 within the portal 210 or may be sent as an e-mail or electronic document to the supplier. The form 714 includes the invoicing data for the invoices 608 and 702. The form 714 includes controls 716a-c that allow the supplier to select whether or not the invoices are duplicates of one another, add a note to the form 714, and to submit the form 714 back to the IMS 110, respectively.

FIG. 7H is a user interface showing an example of the supplier invoice exception clarification form 714 of the SRM module. Here, the supplier has indicated in the note control 716b that the goods were sent the day before. The supplier has indicated in the selection control 716a that the invoices 608 and 702 are not duplicates of one another. The supplier selects the submit control 716c to send the form 714 back to the IMS 110.

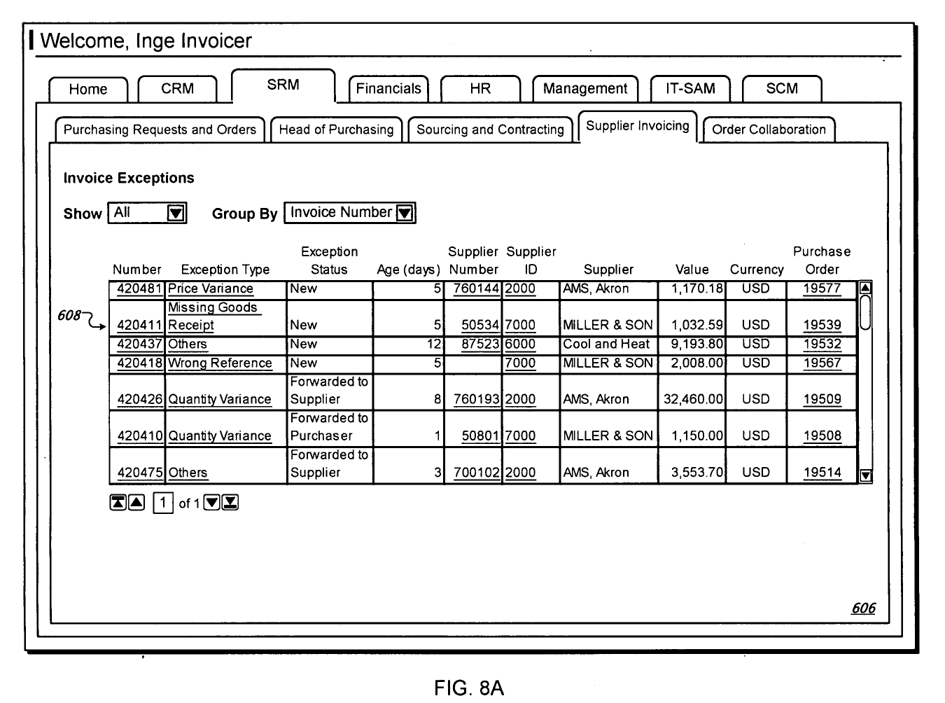

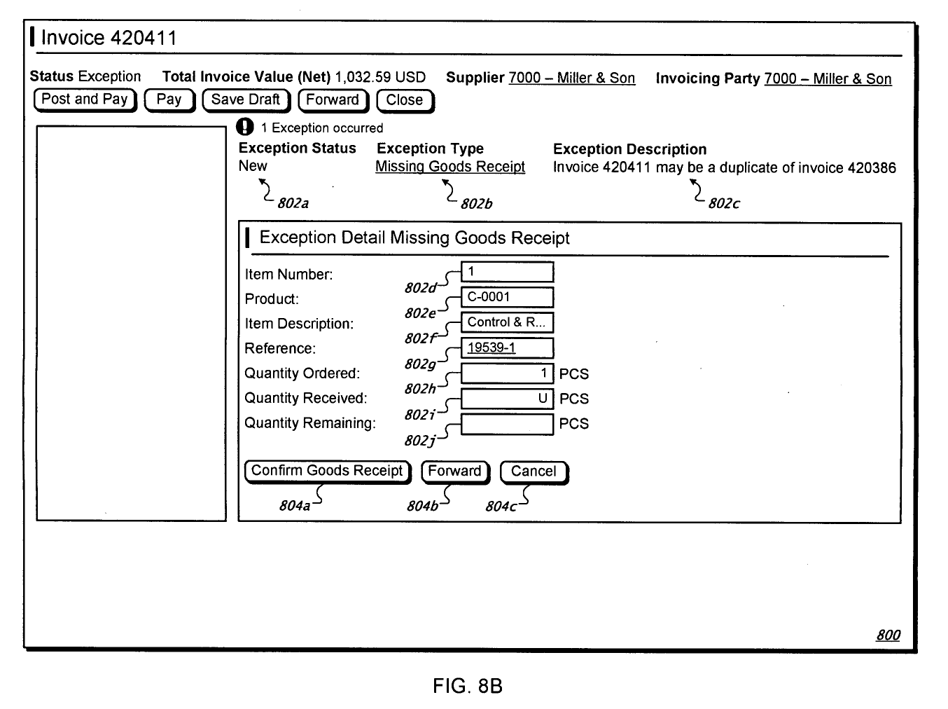

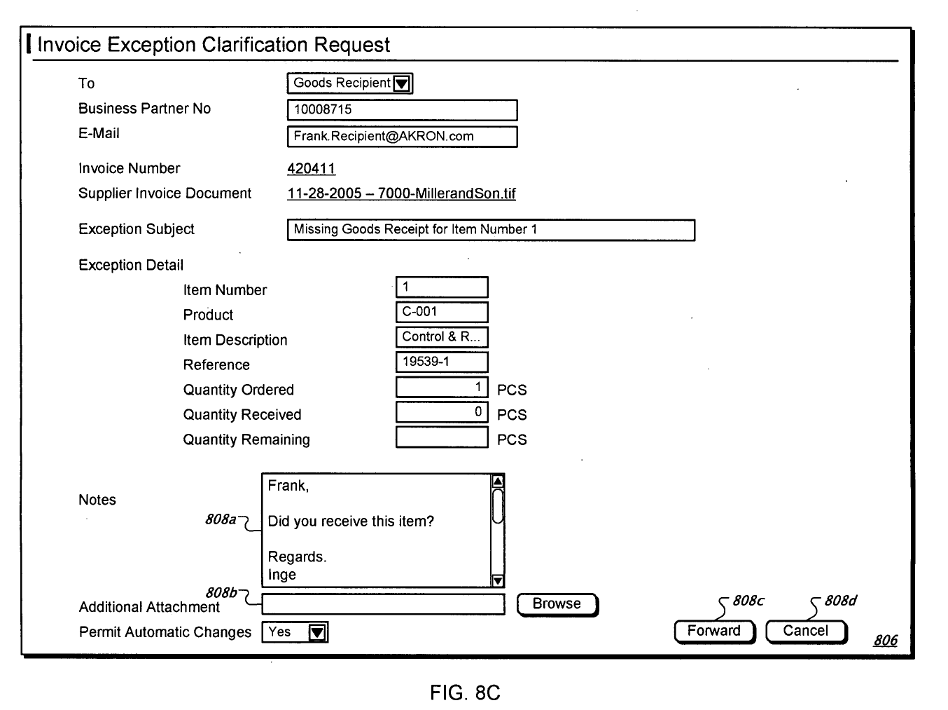

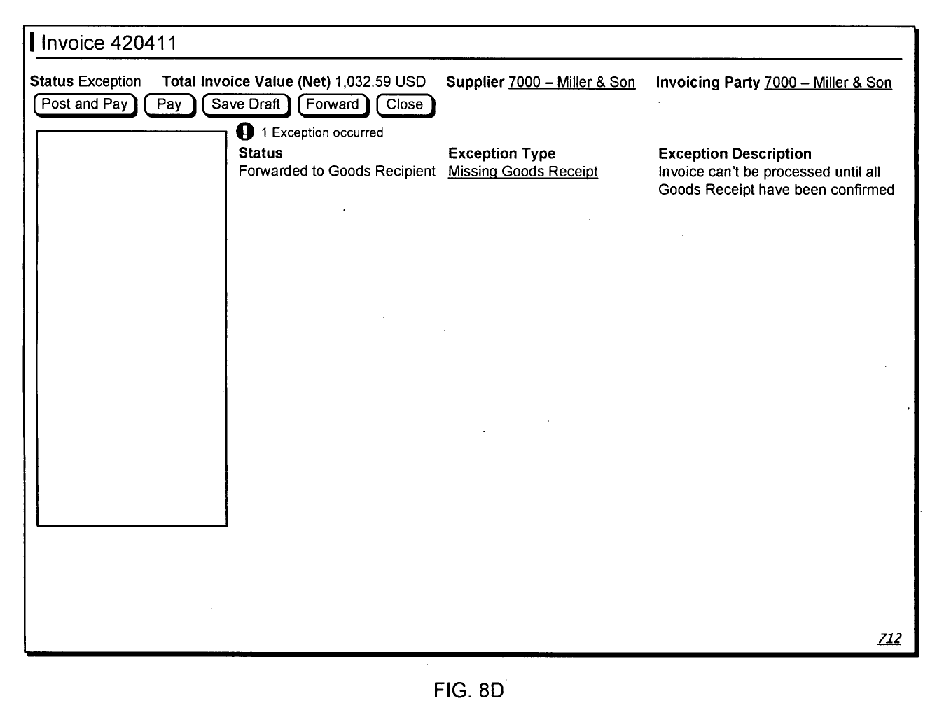

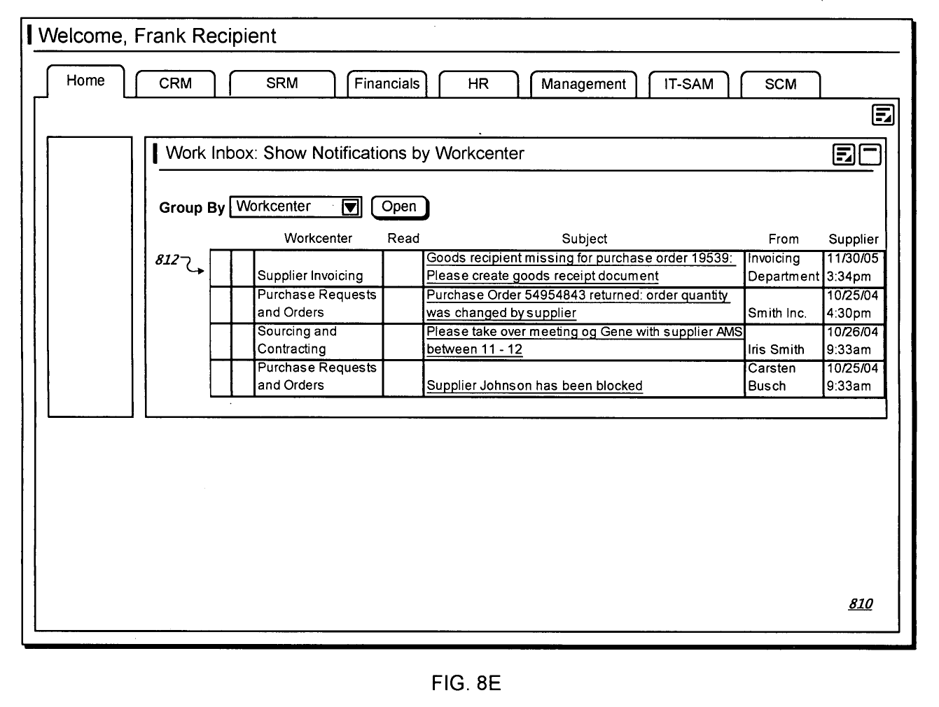

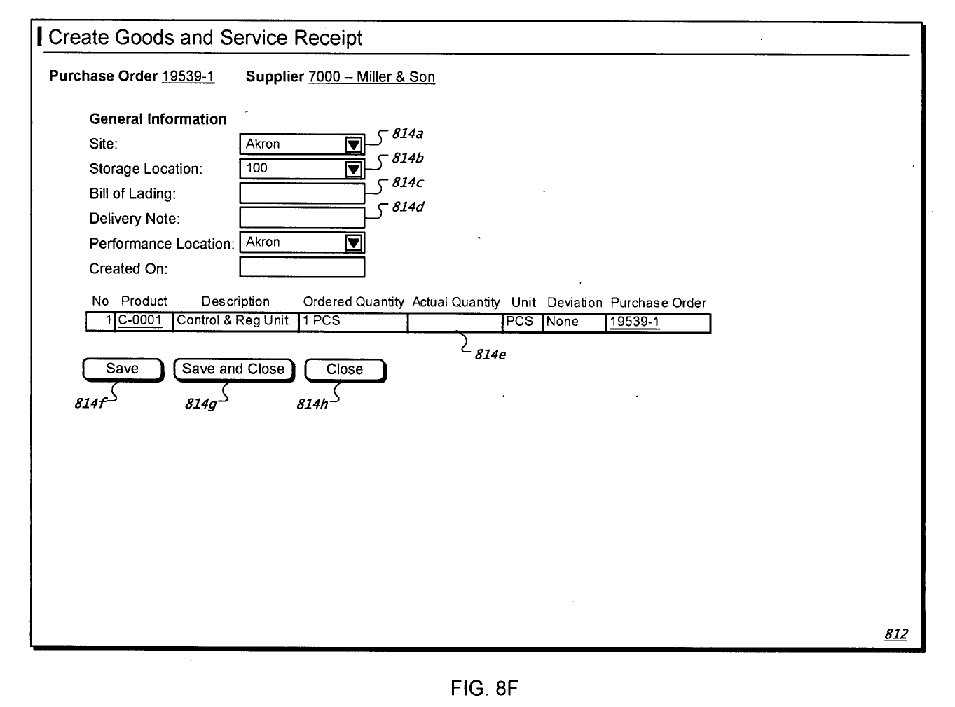

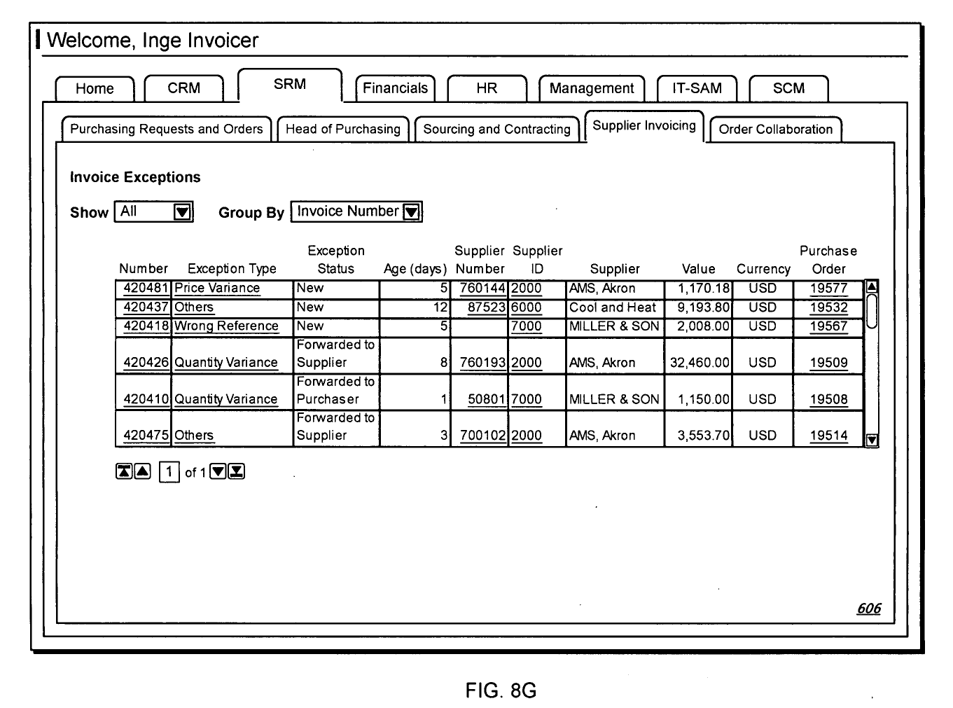

FIG. 8A is a user interface showing an example of the supplier invoicing exception list 606 of the SRM module. After receiving the form 714, the IMS 110 updates the status of the invoice 608 in the list 606. The possible duplicate exception for the invoice 608 has been removed from the list 606, but the list 606 now includes a missing goods receipt for the invoice 608. The user selects the invoice 608 and is directed to an invoice exception detail view.

FIG. 8B is a user interface showing an example of a supplier invoicing exception detail view 800 of the SRM module. The view 800 may be provided by the IMS interface 214 within the portal 210. The view 800 includes information 802a-j indicating a status of the exception, a type of the exception, a description of the exception, an item number, a product, an item description, a reference number, a quantity ordered, a quantity received so far, and a quantity received yet, respectively. The view 800 also includes controls 804a-c to confirm the goods receipt, forward the exception, and cancel viewing the exception, respectively. The user believes that the goods may have been received, but the receipt may not have been entered yet. The user contacts the goods recipient for input. Here, the user selects the forward control 804b and is directed to an invoice exception clarification request.

FIG. 8C is a user interface showing an example of a supplier invoice exception clarification request 806 of the SRM module. The request 806 may be provided by the IMS interface 214 within the portal 210. The request 806 includes the invoicing data for the invoice 608. The request 806 also includes controls 808a-d that allow the user to add a note to the request 806, add an attachment to the request 806, send the request 806, or cancel the request 806, respectively. Here, the user selects the send control 808c and the request 806 is sent to the goods recipient.

FIG. 8D is a user interface showing an example of the supplier invoice exception view 712 of the SRM module. As a result of forwarding the exception to the goods recipient, the view 712 now indicates that the invoice 608 has a “forwarded to goods recipient” status, while the type remains as “missing goods receipt.” Here, the user selects the cancel control 704d and is directed back to the list 606.

FIG. 8E is a user interface showing an example of a portal notifications inbox 810 of a goods recipient. The inbox 810 may be provided by the portal 210. The inbox 810 includes notifications to the goods recipient from various modules, such as the SRM module. In particular, the inbox 810 includes a supplier invoice exception clarification form 812 resulting from the request 806. The goods recipient selects the form 812 and is directed to a detailed view of the form 812.

FIG. 8F is a user interface showing an example of the supplier invoice exception clarification form 812 of the SRM module. The form 812 may be provided by the IMS interface 214 within the portal 210. The form 812 allows the goods recipient to create a goods and services receipt. The form 812 includes controls 814a-h that allow the goods recipient to specify a site, storage location, bill of lading, delivery note, and performance location, as well as to save, save and close, or close the form 812, respectively. Here, the goods recipient enters appropriate data and selects the save and close control 814g.

FIG. 8G is a user interface showing an example of the supplier invoicing exception list 606 of the SRM module. After the IMS 110 receives the form 812, all exceptions for the invoice 608 are cleared. As a result, the list 606 no longer shows the invoice 608.

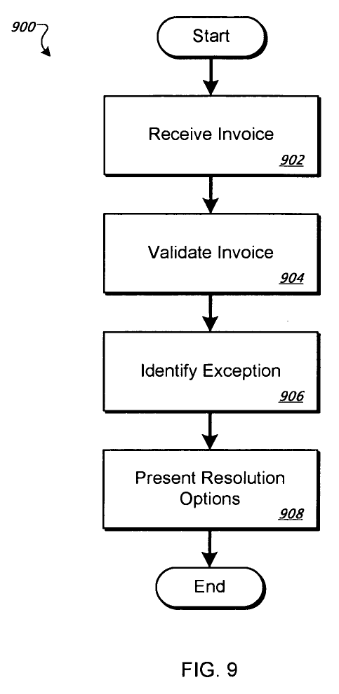

FIG. 9 is a flow chart showing an example of a process 900 for facilitating invoice exception management. The process 900 begins at step 902 with receiving an invoice into a distributed business application. For example, an invoicing clerk may input an invoice using the interface 214 of the IMS 110. Alternatively, the invoice may be submitted to the IMS 110 electronically by a third party, such as a supplier.

In certain implementations, the process 900 validates various portions the invoice at step 904. For example, the IMS 110 may verify that required data is present or that data provided matches a type and/or content of data expected for a particular invoice portion. Next, at step 906, the process 900 identifies an exception to the invoice. For example, data identified as missing or invalid during the validation (at step 904) may be raised as an exception or error during processing of the invoice. In certain implementations, the exception is one of invoice duplication, missing external information, missing internal information, missing goods receipt, incorrect reference, approval overdue, price variance, quantity variance, or tax variance.

At step 908, the process 900 automatically presents resolution options for the identified exception to the via an appropriate invoice center interface. For example, the IMS 110 may present one or more exceptions to the invoice using the interface 214. In certain implementations, the resolution options include one or more of accept exception, reject invoice, re-key at least a portion of the invoice, contact internal people, or contact external people.

In certain implementations, presenting resolution options includes processing the identified exception using a plurality of exception rules. The exception rules identify appropriate resolutions for the identified exception. The process 900 presents a particular presentation using the invoice center interface based on the identified resolution. The particular presentation may include a notification that the resolution was automatically initiated. In addition, the particular presentation may include a display of recommended procedures for resolving the exception.

The preceding flowcharts and accompanying description illustrate an exemplary computer implementable method or process 900. System 100 contemplates using or implementing any suitable technique for performing these and other tasks. It will be understood that these methods are for illustration purposes only and that the described or similar techniques may be performed at any appropriate time, including concurrently, individually, or in combination. In addition, many of the steps in this flowchart may take place simultaneously and/or in different orders than as shown. Moreover, system 100 may use methods with additional steps, fewer steps, and/or different steps, so long as the methods remain appropriate.

Although this disclosure has been described in terms of certain embodiments and generally associated methods, alterations and permutations of these embodiments and methods will be apparent to those skilled in the art. For example, certain embodiments of system 100 may be a standalone, but potentially networked, computer that processes physical documents completed by customers. Accordingly, the above description of example embodiments does not define or constrain this disclosure. Other changes, substitutions, and alterations are also possible without departing from the spirit and scope of this disclosure.

What is claimed is:

1. Invoice management software for facilitating invoice exception resolution comprising computer readable instructions operable when executed to:
receive an invoice into a distributed business application;
identify an exception to the invoice; and
automatically present resolution options for the identified exception to a user via an invoice center interface.

2. The software of claim 1, wherein the receipt of the invoice comprises receipt via an invoice clerk using the invoice center interface.

3. The software of claim 2, wherein the receipt includes validation of various portions of the invoice.

4. The software of claim 1, wherein the receipt of the invoice comprises receiving the invoice electronically from a third party.

5. The software of claim 1, wherein the identified exception is one of the following:
invoice duplication;
missing external information;
missing internal information;
missing goods receipt;
incorrect reference;
approval overdue;
price variance;
quantity variance; or
tax variance.

6. The software of claim 1, wherein the presented resolution comprises one of the following actions by the user:
accept exception;
reject invoice;
rekey at least a portion of the invoice;
contact internal people; or
contact external people.

7. The software of claim 1, wherein the invoice center interface displays at least a portion of a plurality of invoices with one or more exceptions via a secured portal.

8. The software of claim 1, wherein automatically presenting resolution options for the identified exception comprises:
processing the identified exception using a plurality of exception rules that automatically identify appropriate resolutions for the identified exception; and
presenting a particular presentation by the invoice center interface based on the identified resolution that facilitates the identified resolution.

9. The software of claim 8, the particular presentation comprising a notification that the resolution was automatically initiated.

10. The software of claim 8, the particular presentation comprising a display of recommended procedures for resolving the exception.

11. The software of claim 1, wherein the user is third party supplier of the invoice.

12. A system for facilitating invoice exception management comprising:
memory storing a plurality of invoices and a plurality of invoice-related data; and
one or more processors operable to:
receive an invoice into a distributed business application;
identify an exception to the invoice; and
automatically present resolution options for the identified exception to a user via an invoice center interface using at least a subset of the invoice-related data.

13. The system of claim 12, wherein the receipt of the invoice comprises receiving the invoice electronically from a third party.

14. The system of claim 12, wherein the identified exception is one of the following:
invoice duplication;
missing external information;
missing internal information;
missing goods receipt;
incorrect reference;
approval overdue;
price variance;
quantity variance; or
tax variance.

15. The system of claim 12, wherein the presented resolution comprises one of the following actions by the user:
accept exception;
reject invoice;
rekey at least a portion of the invoice;
contact internal people; or
contact external people.

16. The system of claim 12, wherein the invoice center interface displays at least a portion of a plurality of invoices with one or more exceptions via a secured portal.

17. The system of claim 12, wherein automatically presenting resolution options for the identified exception comprises:
processing the identified exception using a plurality of exception rules that automatically identify appropriate resolutions for the identified exception; and
presenting a particular presentation by the invoice center interface based on the identified resolution that facilitates the identified resolution, the identified resolution utilizing at least the subset of invoice-related data.

18. The system of claim 17, the particular presentation comprising a notification that the resolution was automatically initiated.

19. The system of claim 17, the particular presentation comprising a display of recommended procedures for resolving the exception.

20. The system of claim 12, wherein the user is third party supplier of the invoice.
